(19) United States
(12) Patent Application Publication
(10) Pub. No.: US 2006/0156238 A1
(43) Pub. Date: Jul. 13, 2006

(54) Systems and methods for providing loops

(75) Inventors: Prescott V. Lee, Menlo Park, CA (US); Kyle S. Mashima, Menlo Park, CA (US)

Correspondence Address: CARR & FERRELL LLP, 2200 GENG ROAD, PALO ALTO, CA, 94303, US

(73) Assignee: FilmLoop, Inc.

(21) Appl. No.: 11/173,601

(22) Filed: Jul. 1, 2005

Related U.S. Application Data
(60) Provisional application No. 60/644,254, filed on Jan. 13, 2005.
(60) Provisional application No. 60/644,129, filed on Jan. 13, 2005.

(51) Int. Cl. H04B 1/20

(52) U.S. Cl. 715/723; 707/100; 369/2; D14/496

(57) ABSTRACT

A system and method for providing loops are provided. The method comprises creating a loop. One or more items of media are forwarded to the loop. The one or more items of media are included in the loop.

### CROSS-REFERENCE TO RELATED APPLICATIONS

The present application claims the benefit and priority of U.S. provisional patent application Ser. No. 60/644,254 filed on Jan. 13, 2005 and entitled “Systems and Methods for One Click Photo Sharing,” and U.S. provisional patent application Ser. No. 60/644,129, filed on Jan. 13, 2005 and entitled “Systems and Methods for Drag and Drop Loops,” which are herein incorporated by reference.

This application is related to co-pending U.S. application Ser. No. ___/___, entitled “Systems and Methods for Single Act Media Sharing,” filed on Jul. 1, 2005, co-pending U.S. application Ser. No. ___/___, entitled “Systems and Methods for Providing an Interface for Interacting with a Loop,” filed on Jul. 1, 2005, co-pending U.S. application Ser. No. ___/___, entitled “Systems and Methods for Single Input Installation of an Application,” filed on Jul. 1, 2005, co-pending U.S. application Ser. No. ___/___, entitled “Systems and Methods for Sharing Loops,” filed on Jul. 1, 2005, and co-pending U.S. application Ser. No. ___/___, entitled “Loop Channels,” filed on Jul. 1, 2005, which are herein incorporated by reference.

### BACKGROUND OF THE INVENTION

1. Field of the Invention

The present invention relates generally to media, and more particularly to systems and methods for providing loops.

2. Description of Related Art

Conventionally, in order to organize data, such as documents, images, pictures, audio files, other media, and so on, a user typically creates a file system for storing and locating these items. Related items are often stored in the same folder and organized by a file directory. The file directory allows the user to store and locate items according to a tree system, where files are stored within folders, which may be within other folders, and so on.

When the user elects to view the items, the user can browse the file directory in order to locate the particular item and open the item for display. If the user wants to group several items together, the user can store the items as files within the same folder and open each file in order to view the file contents. Another way the user can group the items together is by saving the items to one file, as a single document. In this case, the user need only open the single file to display the contents of the single document. The user can scroll down the document to display the contents.

With the advent of digital cameras, computer users store numerous pictures on their computers. Because file directories for storing text documents and other types of items are not always as convenient for storing and locating pictures, various software applications have entered the market for organizing pictures on a computer. These software applications sometimes offer virtual photo albums. A user can click through the photo album to view the pictures on each page of the photo album. The pictures on each page of the photo album are usually organized in the photo album according to the user's preference. If the user wishes to find a particular picture, the user can page through the photo album in search of the picture or enter information about the picture into search parameters provided by the software application.

Although various systems are available for organizing the data, the data generally is displayable one file at a time or as a predetermined grouping of files.

Therefore, there is a need for systems and methods for providing loops.

### SUMMARY OF THE INVENTION

Systems and methods for providing loops are provided. In one embodiment, a method comprises creating a loop. One or more items of media are forwarded to the loop. The one or more items of media are included in the loop.

In another embodiment, a system for providing a drag and drop loop is provided. A loop is provided. A server is also provided for associating one or more items of media that populate the loop with the loop and. A media engine modifies the loop based on user interaction with the loop.

### BRIEF DESCRIPTION OF THE DRAWINGS

FIG. 1 illustrates an exemplary environment for providing a loop;

FIG. 2 illustrates an screen shot of an exemplary loop;

FIG. 3 illustrates a flow diagram for providing an exemplary modifiable loop(s);

FIG. 4 illustrates a flow diagram for creating a loop;

FIG. 5 illustrates a schematic diagram for an exemplary media engine;

FIG. 6 illustrates exemplary components associated with the server; and

FIG. 7 illustrates an exemplary graphical user interface (GUI) for providing access to functions related to the media engine.

### DESCRIPTION OF EXEMPLARY EMBODIMENTS

A loop is provided for displaying media in association with a computing device related to a user. In one embodiment, a loop is a Film loop™. The user may select various media to display using the loop. The loop may scroll the media across a display device associated with the computing device, or across any other display associated with any type of device. According to various embodiments, the media selected by the user for the loop may be shared with one or more other users at one or more other computing devices when the user drags the media to the loop, if the one or more other users share the same loop on their respective computing devices. Various other features associated with the loop are described herein.

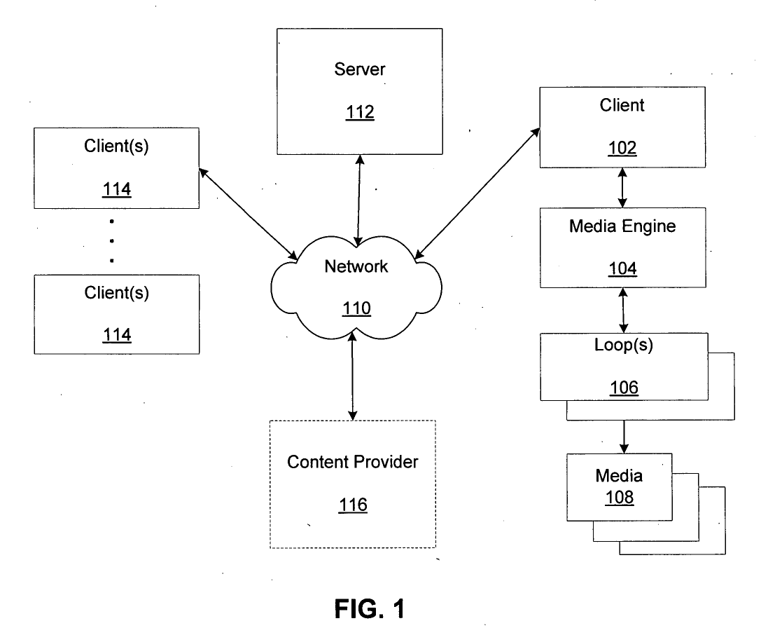

Referring to FIG. 1, an exemplary environment for providing single act media sharing is shown. A user is associated with a client 102. The client 102 includes any type of computing device, such as a cellular telephone, a laptop computer, a personal digital assistant (PDA), and so on. The client 102 has a media engine 104 coupled to the client 102 for creating and/or generating at least one loop 106. The media engine 104 may also play the loop 106. The loop 106 may be comprised of various media 108. A loop player comprises the graphical representation of the media engine 104.

The media 108 can include photos, video, audio, images, text, advertisements, and/or any other type of media. The media 108 may appear as one or more items separated by lines, frames, or any other display item for defining the one or more items of the media 108 as separate from each other. Each frame of the media 108 may itself include moving displays, motion pictures, and so forth.

In one embodiment, the loop 106 scrolls, or is otherwise played, across a display associated with the client 102. In some embodiments, the loop 106 may be manipulated by a user of the client 102 to stop, speed up or slow down the scrolling of the loop 106, and/or any other type of manipulation. The client 102 may have more than one loop 106 that scrolls across the display at one time. Further, the client 102 may have various loop(s) 106 that play at one time and/or are stored at the client 102 to be played at a time chosen by the user associated with the client 102. The user may also play more than one loop 106, such as playing the loops 106 sequentially, in a single media engine 104.

The media engine 104 may reside on the client 102 or may be otherwise coupled to the client 102. Alternatively, the media engine 104 may be accessible to the client 102 via a network, such as the network 110 shown in FIG. 1. For example, one or more clients may access the media engine 104 via a network in order to create the loop(s) 106, update the loop(s) 106 with additional media 108, remove certain of the media 108 from the loop(s) 106, alter metadata associated with the loop(s) 106, modify the media 108 or metadata associated with the media 108 contained in the loop(s) 106, play the loop(s) 106, and/or perform any other functions utilizing the media engine 104.

In exemplary embodiments, the identifier assigned to the media 108 may be unique within the loop(s) 106. Further, the loop(s) 106 identifier and/or the media 108 identifier is unique within the network 110, according to exemplary embodiments. Any type of identifiers may be assigned to the loop(s) 106 and/or the media 108 according to various embodiments.

The media engine 104 may be utilized, as discussed herein, to create the loop(s) 106 using the media 108. Typically, the user at the client 102 selects the media 108 from files located on the client 102 and/or from media 108 available via the network 110. For example, the user may search for provide photos found on the Internet to the media engine 104. The media engine 104 receives the media 108 and creates the loop(s) 106 with the media 108. The user can provide more than one item of the media 108 to the media engine 104 for creating or modifying the loop(s) 106.

The user can provide the media 108 by dragging and dropping the media 108 into the media engine 104, by initiating a command that the media 108 be used to create a new loop(s) 106 and/or modify an existing loop 106, and/or any other method of identifying the media 108 as part of the loop(s) 106. In exemplary embodiments, the user can drag a folder including more than one item of the media 108 into the loop(s) 106.

The media engine 104 may assign an identifier to each of the loop(s) 106. The media engine 104 may further assign an identifier to each of the media 108 in the loop 106. For example, the media engine 104 may assign an identifier to a loop 106 that is newly created and may also assign identifiers to each of the media 108 used to create the new loop 106. In one embodiment, the media 108 may receive the same or similar identifier as the loop 106 to which the media 108 belongs.

The loop(s) 106 may be stored by category, dates associated with the media 108 included in the loop(s) 106, metadata associated with the loop(s) 106, or any other criteria. The criteria may be provided to the user as a default and/or the user can specify criteria for storing and/or playing the loop(s) 106. For example, in one embodiment, the user may specify that the loop(s) 106 should be played one at a time, one per day, according to a particular subject matter, such as family photo loop(s) 106, followed by fan club loop(s) 106, followed by work oriented loop(s) 106, and so forth. Any method for playing the loop(s) 106 is within the scope of various embodiments.

When the user drags and drops one or more items of the media 108 into a particular loop 106, the user is requesting that the media engine 104 modify the particular loop(s) 106 by adding the one or more items of the media 108. Accordingly, the media engine 104 assigns an identifier that is unique within the loop 106 to each of the items of the media 108 dropped by the user.

As discussed herein, the media 108 may be added to more than one loop(s) 106. Accordingly, the media 108 may have more than one identifier associated with the media 108 in order to identify the one or more loop(s) 106 which contain the media 108.

In order to add the media 108 to a loop 106 without using methods the drag and drop method, the user can identify the media 108, to be added and subsequently include the media 108 into the loop(s) 106 of the media engine 104. For example, the user may copy the media 108 from outside of the loop(s) 106. Subsequently, the user may paste the media 108 into the loop(s) 106. The user can identify the loop 106 according to the loop's 106 identifier, by subject matter, and/or by any other criteria that indicates to the media engine 104 which loop 106 should receive the media 108 being provided by the user.

The user can remove media 108 from a loop 106 by dragging the media 108 out of the loop 106, or identifying to the media engine 104 the media 108 to remove. Any manner of identifying the media 108 the user desires to remove from a loop 106 is within the scope of various embodiments. For instance, the user can highlight the item of the media 108 within the loop 106 and select a remove option from a drop down menu.

The media engine 104 updates the loop 106 to reflect the removal of the media 108. The media engine 104 may remove the identifiers associated with the removed media 108 or the media engine 104 can alter the metadata associated with the removed media 108. Conversely, as discussed herein, the user can add the media 108 back into a loop 106 by dragging and dropping the media 108 into the loop 106 to which the user wishes to add the media 108 or by identifying the media 108 to the media engine 104 that the user wishes to add to the loop 106.

In one embodiment, the identifiers for the loop(s) 106 and/or the media 108 may be assigned by a server 112, such as an “application server.” The server 112 may be accessed directly by the client 102 or via the network 110. The server 112 can communicate the identifiers for the loop(s) 106 and/or the media 108 to the media engine 104, so the media engine 104 can store and locate the identifiers.

When the user removes, adds, or modifies an item of the media 108 from the loop 106, the server 112 can store and/or track the removals, additions, and/or modifications as updates to the loop 106. The user can also update the loop 106 by making changes to items of the media 108 in the loop 106. For example, if the user resizes an image of the media 108, the media engine 104 and/or the server 112 can include the resized image as an update to the media 108 in the loop 106. In one embodiment, the server 112 may assign the identifier to the resized image in the media 108 and include the resized image as an update to the media 108 in the loop(s) 106. Any type of modifications to the media 108 and/or the loop 106 is within the scope of various embodiments.

In one embodiment, the user of the client 102 shares one or more of the loops 106 with one or more users of one or more other clients 114. The other clients 114 may also include one or more media engines for playing the loop(s) 106, creating the loop(s) 106, modifying the loop(s) 106, and so on. The server 112 assigns the same identifier to the loop(s) 106 shared by the client 102 and the client(s) 114.

When a user from the client 102 makes updates to the loop(s) 106 having an identifier shared by the loop(s) 106 at the client(s) 114, the client(s) 114 receive the same updates to the loop(s) 106. As discussed herein, the updates may include any modifications to the loop(s) 106 and/or the media 108 comprising the loop(s) 106.

The server 112 can provide the updates to the loop(s) 106 on the client(s) 114 automatically, at any time after the user at the client 102 makes updates to the loop(s) 106. In one embodiment, the server 112 makes requests to the media engine 104 at various times for changes made to the loop(s) 106 at the client 102. In one embodiment, the server 112 waits for notifications from the client(s) 114 of changes made to the loop(s) 106, then provides the updates to the client(s) 114 that have loops 106 with the same identifiers. Similarly, changes made by the client(s) 114 may be automatically provided to the client 102.

In one embodiment, the media engine 104 or any other component associated with the client 102 assigns a temporary identifier to the media 108 dragged into the loop 106. The client 102 then forwards the media 108 with the temporary identifier to the server 112. The server assigns a permanent identifier to the media 108 and forwards the media 108 with the permanent identifier back to the client 102 and/or to the other client(s) 114 as an update. The temporary identifier associated with the media 108 and/or the permanent identifier associated with the media 108 may further be associated with the identifier assigned to the loop(s) 106. Any type of method for assigning identifiers to the media 108 and/or the loop 106 may be employed by any device according to various embodiments.

The one or more users at the client(s) 114 may also make updates to the loop(s) 106 that have the same identifiers as the loop(s) 106 at the client 102. In one embodiment, the user that originates a shared loop 106 can create permissions for the loop 106. For instance, the originating user may require a password before other users can submit updates to the shared loop(s) 106.

Since the server 112 may automatically distribute the updates to the client(s) 114 with loop(s) 106 that have shared identifiers, only a single act is required by the user to share the updates to the loop(s) 106 with the users at the client(s) 102 and 114.

In one embodiment, users may subscribe to loop(s) 106. For example, the user at the client 102 may post movie oriented loop(s) 106 to the Internet and other users may subscribe to those movie oriented loop(s) 106 via a registration process. For users that subscribe to the movie oriented loop(s) 106, updates are received when the originating user makes modifications to the movie oriented loop(s) 106. As discussed herein, a user, vendor, retailer, advertiser, etc. may make loop(s) 106 available for subscription.

Once the loop(s) 106 have been setup by various users and assigned unique identifiers, the server 112 and/or the media engine 104 keeps track of the loop(s) 106 and any changes thereto. Accordingly, since the server 112 automatically distributes, or otherwise distributes, the updates to the client(s) 114 with the loop(s) 106 with shared identifiers based on the user at the client 102 modifying the loop(s) 106 by adding, removing, or changing one or more items of the media 108 within the loop(s) 106, only a single act is required by the user to share the updates to the loop(s) 106 with the users at the client(s) 114.

In one embodiment, master copies of the loop(s) 106 may be stored on the server 112. Accordingly, the user at the client 102 can modify the loop(s) 106 by accessing the server 112. The user may access the server 112 via the network 110 or in any other manner. Alternatively, the server 112 may include an index for locating the various loop(s). In another embodiment, the loop(s) 106 may be stored at the server 112, while the client 102 and/or the client(s) 114 utilize an index to retrieve particular loop(s) 106 when desired. Any storage medium may be utilized for storing the loop(s) 106, copies of the loop(s) 106, metadata, and/or indexes according to various embodiments.

In another embodiment, the server 112 may store the master copies of all the loop(s) 106 for all users along with the identifiers for the loop(s) 106 and the media 108. Accordingly, the server 112 can search for loop(s) 106 based on the identifiers, receive updates to the loop(s) 106 when users associated with the loop(s) 106 makes changes to the loop(s) 106, and automatically distribute updates for the loop(s) 106 to all user associated with the loop(s) 106. In still another embodiment, the loop(s) 106 may be stored on the server 112 in order to minimize storage on the client 102 and/or the client(s) 114, as discussed herein.

In still another embodiment, the server 112 may store versions of the loop(s) 106. Accordingly, the server 112 may maintain various copies of the same loop(s) 106, as different versions. According to another embodiment, the client 102 and/or 114 may store different versions of loop(s) 106 generated by the client 102 or of shared loop(s) 106. The server 112 and/or the client 102 may maintain an index for organizing and tracking the various versions of the loop(s) 106 according to some embodiments.

In one embodiment, a content provider 116 is coupled to the server 112 in order to provide content for the loop(s) 106. The content provider 116 may be directly coupled to the server 112 or the content provider 116 may be coupled to the server 112 via the network 110. In one embodiment, the content provider 116 is coupled to the client 102 and/or the client(s) 114 in order to directly provide the content to the loop(s) stored on the client 102 and/or the client(s) 114.

In exemplary embodiments, the content provider 116 provides advertising content to the loop(s) 106. Alternately, the content provider 116 may provide any type of content. In one embodiment, each of the loops 106 must include at least one item of the content from the content provider 116. More than one content provider 116 may be provided according to various embodiments. Accordingly, the loop(s) 106 may display advertisements or other content along with the other media 108 displayed by the loop(s) 106.

In one embodiment, the content provider 116 can specify how often the content appears within the loop(s) 106. For example, the content provider 116 may specify that the content should appear no less than between every 10^{th} item of media 108 within the loop(s) 106. If the content provider 116 modifies the content, the server 112 or the content provider 116 itself, can distribute the modified content as updates to the loop(s) 106. Accordingly, the modified content replaces the existing content in the loop(s) 106.

In one embodiment, digital content may be emailed to a central authority representing the loop(s) 106. The central authority may then authenticate the user and distribute the digital content to appropriate loop(s) 106 and/or create new loop(s) 106 based on the digital content. The authentication may be based on usemame, password, and/or any other information related to the user submitting the digital content.

Although the media engine 104 at the client 102 is described as creating the loop(s) 106 from the media 108, one or more media engines at the client(s) 114 can also provide the media 108 and create the loop(s) 106, modify the loop(s) 106, and so on. In other words the client 102 and the client(s) 114 are capable of performing similar or identical functions with respect to the loop(s) 106.

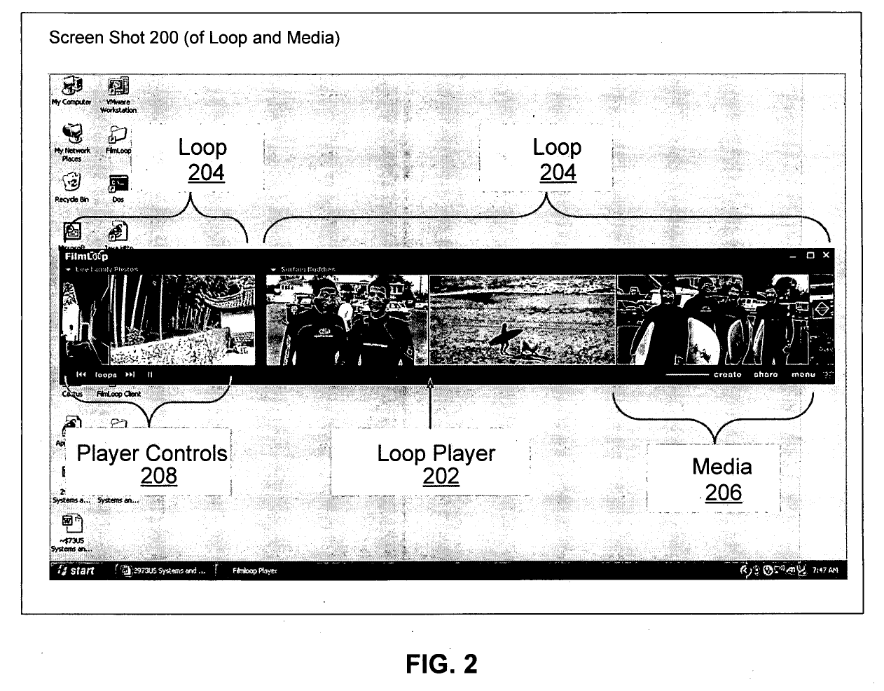

Referring now to FIG. 2, a screen shot of an exemplary loop 204, such as the loop(s) 106 discussed in FIG. 1, in accordance with one embodiment is shown. A loop player 202, such as the media engine 104 discussed in FIG. 1, includes several loops 204. Each loop 204 includes several items of media 206, such as the one or more items of the media 108 discussed in FIG. 1. The loop player 202 plays the loop 204 by scrolling the various media 206 across a display associated with a user. The display associated with the user in FIG. 2 is a desktop display.

In FIG. 2, is a screen shot 200 of the loop player 202 displaying two loops 204, one entitled “Lee Family Photos” and the other entitled “Surfing Buddies.” As shown, one item of the media 206 in the “Surfing Buddies” loop 204 is a picture of four surfers. As discussed herein, various types of media 206 may be included in the loop(s) 204, such as the photograph of the four surfers, advertising content from a content provider, such as the content provider 116 discussed in FIG. 1, and so on. Although FIG. 2 shows two or more loops 204 adjacent to one another being played by the same media engine 104, only one loop 106 may scroll across a display associated with a user according to various embodiments. In one embodiment, the user may scroll more than one loop 106 across the display device at different locations on the display device, rather than adjacent loops 106 played in one media engine 104, as discussed herein. Further, more than one loop 106, including adjacent-loops 106 played by one media engine 104, may scroll across the display device of the user.

The loop player 202 may scroll the media 206 for the loop 204 across the desktop display at any speed and/or in any direction. The speed and/or direction may be a default speed, a default direction, and/or a direction and/or speed specified by the user. In one embodiment, the content provider 116 specifies the speed in order to ensure that the content provided appears at specified increments of time. In one embodiment, the server 112 may also specify the speed and/or the direction in one embodiment.

The user may utilize player controls 208 to adjust the speed, the media 108 to display, and so on. For instance, the user can skip to a previous or next item of the media 108 by utilizing the player controls 208. The user can also pause the scrolling loop(s) 203. The user can stop the loop 202, reduce or expand the size of the loop 202, or minimize the loop 202. In one embodiment, the user may access a master set of controls that control more than one film 106. In another embodiment, when the user adjusts the player controls 208 associated with the loops 106, other users' loop(s) 106 with the same unique identifier are automatically adjusted as well.

In order to drag the loop 204 and/or the loop player 202 to other areas of the desktop display shown in FIG. 2, or any other type of display, the user can grab the loop player 202 and move it to the desired area with a mouse, a keyboard, or any other control device. The user can incorporate the loop 204 into another loop, such as the loop(s) 106 discussed herein, by dragging and dropping the loop 204 into the other loop(s).

The user can drag the media 206 from the loop 204 to another loop to modify the other loop with the media 206 that was dragged to the other loop. In one embodiment, the user may select from a drop down menu to copy and/or move the media 206 to another loop.

In one embodiment, the user may select a single frame from of the media 108, such as the photo of the four surfers from the media 206 described in FIG. 2, in order to “open” the single frame or load a new loop associated with the single frame. Opening the single frame of the media 206 may enlarge the content that comprises the single frame, display an alternate version of the media 206 that comprises the single frame, make the content available for editing, stop the single frame content from moving (in the event of moving displays), direct the user to a URL address, and so on.

Opening the single frame of the media 108 may also expose a new loop, or “sub loop”, associated with the single frame of the media 108. For instance, if a user associated with the loop 202 discussed in FIG. 2 selects the frame with the photo of the four surfers in the media 206 in the “Surfing Buddies” loop 204, a new loop with more surfing buddies photos and/or content may be revealed. Opening a single frame of the media 108 including an advertisement may reveal a new loop with content provided solely by a content provider, such as the content provider 116 discussed in FIG. 1. Any type of new loop may be provided as a consequence of opening the single frame of the media 108, such as the media 206 described in FIG. 2.

In one embodiment, when the user selects a single frame of the media 206, the loop player 202 can make a request to a client, such as the client 102 and/or the client(s) 114 discussed in FIG. 1, to launch a particular application running on the client 102 and/or the client(s) 114. For example, when a particular frame of the media 206 in the loop 204 is selected, the loop player 203 can invoke a web browser installed on the client 102 instructing the web browser to display a particular web page. The web page may be associated with subject matter for the single frame of the media 206.

In one embodiment, opening a single frame of the media 108 may provide an additional option of sending the single frame of the media 108 to one or more other users. For example, although two users may not share the loop(s) 106 with the same unique identifier, the two users may maintain the loop(s) 106 with similar subject matter. Accordingly, the users may send one or more of the single frames of the media 108 to one another in order to update content, inform one another of advertising, etc.

One or more of the frames of the media 108 can be shared between any users for any reason. In one embodiment, the content provider 116 (FIG. 1) pushes time sensitive information to users of the loop(s) 106 as one or more frames of the media 108. Any type of information may be provided to users of the loop(s) 106, such as news, financial data, sales information, new product offerings, single frames of the media 108 from other loop(s) 106 users, and so on. In one embodiment, the users of the loop(s) 106 can block single frames of the media 108 from being presented.

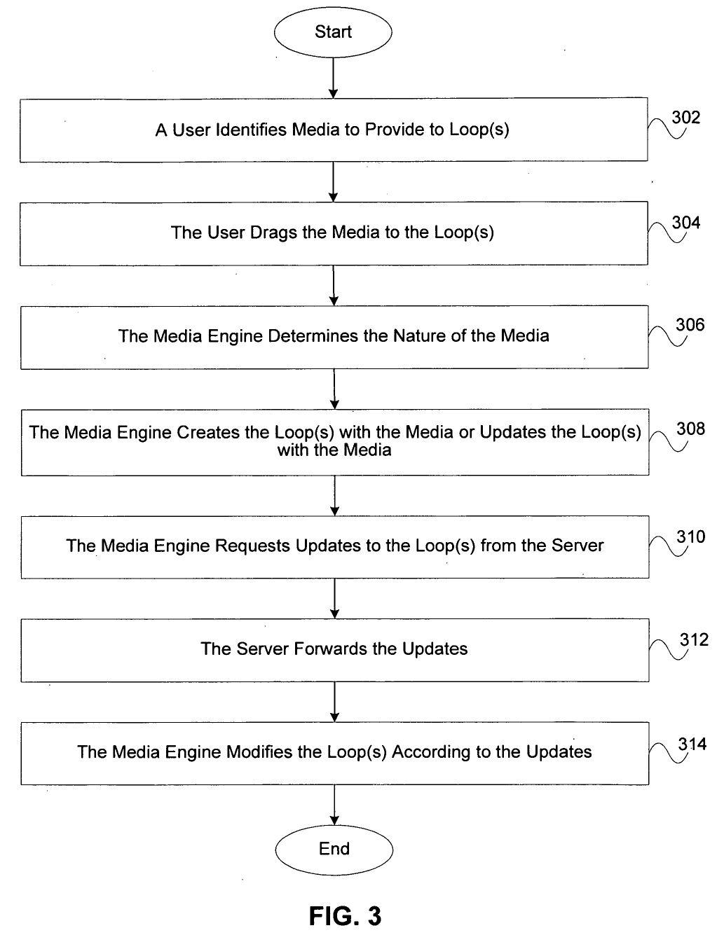

FIG. 3 illustrates a flow diagram for providing an exemplary modifiable loop(s) 106, such as a drag and drop loop(s) 106, in accordance with one embodiment. At step 302, a user identifies the media 108 to provide to the loop(s) 106. As discussed herein, the media can include photos, video, audio, images, text, advertisements, and/or any other type of media. The user can access the media 108 from files on the client 102 or from third party sources utilizing the network 110.

At step 304, the user drags the media 108 into the loop(s) 106. More than one loop(s) 106 may appear on a display associated with the user. The user can drag and drop the media 108 to one or more of the loop(s) 106 on the display. Specifically, the media 108 may be dragged and dropped into the media engine 104, such as the loop player 202 discussed in FIG. 2. Alternatively, the user can drag and drop the media 108 to an icon representing the loop(s) 106 generally and then specify in which loop(s). 106 the user wants the media 108 to appear. However, any manner of providing the media 108 to the loop(s) 106 is within the scope of various embodiments.

At step 306, the loop(s) 106, and specifically the media engine 104, determines the nature of the media 108. For example, the media engine 104 determines whether the media 108 is an image file, a text file, a video file, a hypertext link, etc.

At step 308, the media engine 104 creates the loop(s) 106 or updates the loop(s) 106 using the media 108 received from the user. The media engine 104 can store the loop(s) 106 along with the media 108 in a local database, at the client 102.

The loop player may examine the data comprising each item of the media 108 for specific information included in the data. For example, specific information may be included in the data for an image file and the specific information is read by the media engine 104. Based on existence, identification, and/or contents of the specific information, the media engine 104 may undertake particular actions. For example, an identifier for the loop(s) 106 may be included in the specific information, in which case the media engine 104 may issue a request to the server 112 for the media 108 associated with the loop(s) 106 having the identifier. The server 112 may also create a copy of the loop(s) 106 on the client 102 associated with the user who dragged the media 108 into the media engine 104 and/or the loop(s) 106. Any identification and/or examination of data, metadata, and so forth associated with the media 108, such as the specific information discussed herein, may be employed in accordance with various embodiments.

If the media engine 104 determines that the media 108 includes a file folder of one or more items of the media 108, the media engine 104 can extract the media 108 included in the file folder and utilize the media 108 to create a new loop or populate the loop(s) 106 that already exists.

At step 310, the media engine 104 requests updates to the loop(s) 106 from the server 112. The loop(s) 106 may share the unique identifier with loop(s) 106 associated with the other client(s) 114. Accordingly, when the users at the other client(s) 114 update their respective loop(s) 106, the server 112 may forward the updates to the loop(s) 106 at the client 102. As discussed herein, the server 112 may automatically forward the updates upon receipt or the media engine 104 may request updates for the loop(s) 106 with the shared unique identifiers.

At step 312, the server 112 forwards the updates to the media engine 104 at the client 102. As discussed herein, the updates may include additions of media to the loop(s) 106, deletions of the one or more items of media 108 from the loop(s) 106, and/or modifications to the media 108, itself, in the loop(s) 106. Further, additions, modifications, and/or deletions of the metadata associated with media 108 and/or the loop(s) 106 may also constitute updates according to some embodiments.

At step 314, the media engine 104 modifies the loop(s) 106 according to information (i.e., updates) received from the server 112. Accordingly, when the user(s) at the client(s) 114 update the loop(s) 106 sharing the unique identifier with the loop(s) 106 at the client 102, the loop(s) 106 at the client 102 is updated without intervention of the user at the client 102.

The process of sharing loops is described in further detail in co-pending U.S. application Ser. No. ___/___, entitled “Systems and Methods for Single Act Media Sharing,” filed on Jul. 1, 2005, co-pending U.S. application Ser. No. ___/___ entitled “Systems and Methods for Sharing Loops,” filed on Jul. 1, 2005, and co-pending U.S. application Ser. No. ___/___, entitled “Loop Channels,” filed on Jul. 1, 2005, which is incorporated by reference.

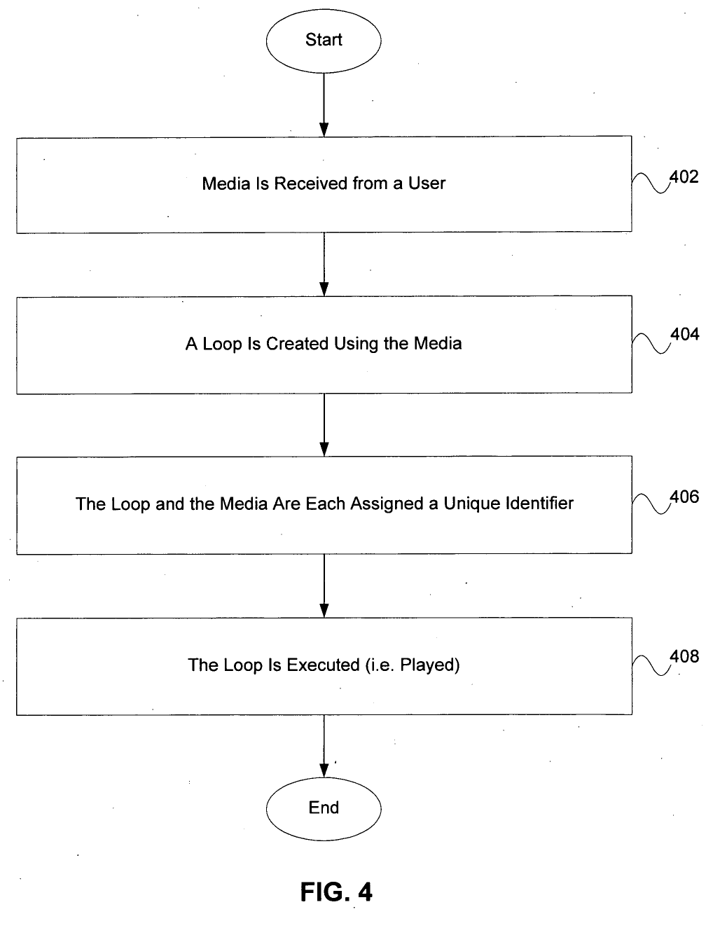

Referring now to FIG. 4, a flow diagram for creating a loop, such as the loop(s) 106 discussed in FIG. 1, is shown. At step 402, one or more items of media, such as the media 108 discussed in FIG. 1, are received. The media is typically received at the media engine 104. As discussed herein, the server 112 may also receive the media 108 as updates or as media 108 for creating a new loop, such as the loop(s) 106 discussed in FIG. 1. According to exemplary embodiments, the user and/or the client 102 may provide the media engine 104 with a title for the loop(s) 106 prior to providing the media 108 for the loop(s) 106.

At step 404, a loop is created using the one or more items of media 108. As discussed herein, for the loop(s) 106 that has already been created and has already been assigned an identifier by the media engine 104 and/or the server 112, the one or more items of media 108 received from the user may be utilized to update the existing loop(s) 106 rather than creating a new loop. In one embodiment, the user can update the existing loop(s) 106 and create a new loop with the same one or more items of media 108. For example, the media engine 104 may update the loop(s) 106 with the one or more items of media 108 and also ask the user if the user wishes to start a new loop with the one or more items of media 108.

At step 406, an identifier is assigned to the loop and to the one or more items of media 108. The identifier may be unique within the network 110 and/or within any other system. As discussed herein, each of the media 108 within the loop(s) 106 may also receive an additional unique identifier. An identifier is assigned to any other media 108 that the user drags and drops into the loop, or forwards to the loop in any other manner. The identifiers for the loop(s) 106 and/or the media 108 may also be assigned by the server 112, as discussed herein. The server 112 can then provide the loop and the one or more items of media 108, as well as any updates, to other users. The other users can then update their loops automatically when the originator of the loop updates the loop, as discussed herein.

The loop is executed at step 408. The media engine 104 may be responsible for executing, or playing, the loop. The loop is populated with the one or more items of media 108 that scroll across a display associated with the user, as shown in FIG. 2.

In one embodiment, a search system may be provided for locating the loop(s) 106 (FIG. 1). For instance, a search engine may be provided for locating individual loop(s) 106, loop topics, and/or a genre associated with the loop(s) 106. A user may post the loop(s) 106 to an online database or provide the loop(s) 106 in any other manner. In one embodiment, the originator of the loop(s) 106 conditions subscription to the loop(s) 106 upon the subscribing users' providing the loop(s) 106, or a specified portion of the loop(s) 106, to a public database. The server 112 may automatically store and make available the loop(s) 106 for searching by the search engine discussed herein. In one embodiment, the users may indicate that the loop(s) 106 are public or private by an identifier. Accordingly, the server 112 may only make the loop(s) 106 identified as public available for searching. As discussed herein, the user may also create permissions associated with the loop(s) 106 for allowing access, types of access, and so forth.

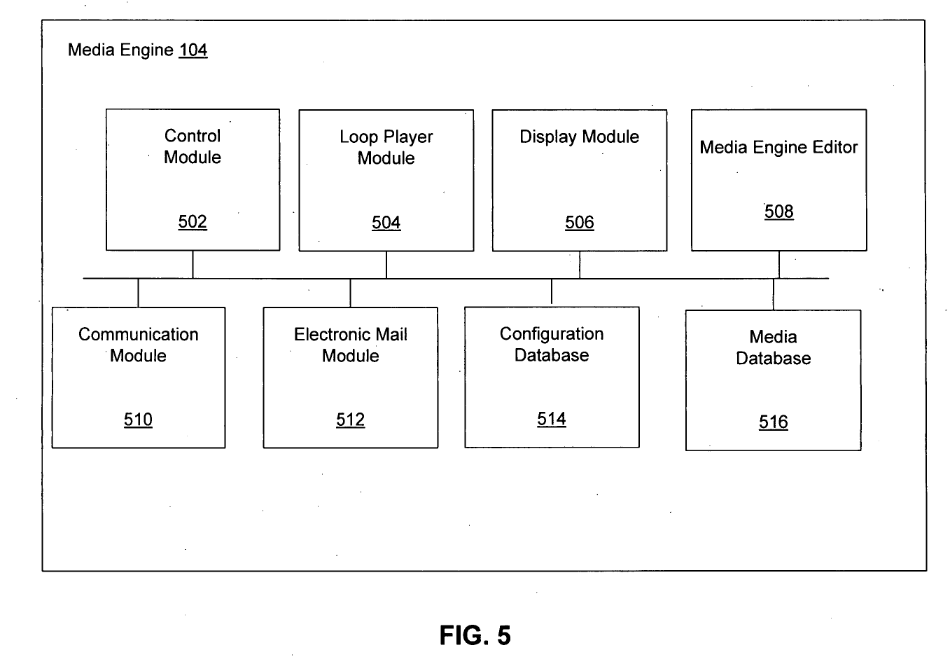

Referring to FIG. 5, a diagram for an exemplary media engine 104 (FIG. 1), such as a loop player, is shown. A control module 502 manipulates the media 108 (FIG. 1) and constructs the loop(s) 106 (FIG. 1) from the media 108. The loop(s) control module 502 can provides a default speed at which the loop(s) 106 plays. In a further embodiment, a user can specify the speed for playing the loop(s) 106 or adjust the speed from the default speed. The loop control module 502 may coordinate with the content provider 116 (FIG. 1) to insert specific content into the loop(s) 106 at specific times or in specific time intervals.

A loop player module 504 plays the loop(s) 106. The loop player 504 may be utilized to control a direction and a speed at which the loop(s) 106 plays. In one embodiment, a user can specify the speed for playing the loop(s) 106.

A display module 506 provides a graphical user interface (GUI) for allowing the user to interact with the logic of the media engine 104. For instance, the display module 506 allows the user to interact with the media engine 104 to read and write the media 108. In other words, the display module 506 allows the user to create, modify, and/or remove the media 108 and/or the loop(s) 106 by choosing from on-screen selections and/or manipulating on-screen items. The display module 506 may also execute the media 108 from within a window, display the media 108, alone or as part of the loop(s) 106, and/or perform any functions related to display and user interaction with the display.

As discussed herein, the display module 506 allows the user to drag and drop the media 108 into the loop(s) 106 and remove the media 108 from the loop(s) 106. The user can drag and drop the media 108, click a button, or initiate a voice command to send the media 108 changes to the media engine 104.

Any type of display module 506 is within the scope of various embodiments. For instance, the display module 506 need not present a typical visual display, but may be a text based display module for allowing the user to interact with logic of the media engine 104 based on text command lines.

A media engine editor 508 allows the user to make adjustments to the media 108. For example, the user can use the media engine editor 508 to resize the media 108, rotate the media 108, configure the media 108, format the media 108, and so forth. For instance, the user may resize an image or change a font type of text associated with the media 108. Any type of editing may be accomplished using the media engine editor 508.

A communication module 510 allows the media engine 104 to utilize components of the client 102 for communicating with the server 112 to send and receive updates for the loop(s) 106 running in the media engine 104, and to transfer any other data between the media engine 104 and the server 112.

An electronic mail interface 512 may be provided as a communications interface for electronic mails. Any type of electronic mail interface 512 may be provided. The electronic mail interface 512 may be utilized for sending the loop(s) 106, the media 108, metadata, or identifiers associated with the loop(s) 106 and/or the media 108 directly to other users.

A configuration database 514 may be utilized to store the one or more identifiers associated with the media 108 or the loop(s) 106. As discussed herein, when the loop(s) 106 is created using the media 108 or updates to the loop(s) 106 are provided, an identifier is assigned to the loop(s) 106 or the media 108. In further embodiments, the media 108 in the loop(s) 106 is assigned an identifier that is unique within the loop(s) 106.

The configuration database 514 may store any type of data related to the loop(s) 106, such as information regarding a host computer system, type and quality of an attached network, communications performance, registration information for the client 102, version number for the loop(s) 106 and the media 108 comprising the loop(s) 106. Any type of configuration database 514 may be utilized in accordance with various embodiments. As discussed herein, in one embodiment, the identifier is stored on the server 112 and/or in the configuration database 514. In alternative embodiments, the configuration database 514 may comprise more than a database. In yet a further embodiment, the configuration database 514 may be located outside the media engine 104, but coupled thereto. It should be noted that the configuration database 514 and the media database 516 may comprise a single database.

A media database 516 maybe provided for storing the media 108. In one embodiment, the content from the content provider 116 is stored in the media database 516. Any process for storing the media 108 may be utilized in association with the media database 516. For example, a hash function may be utilized to index and retrieve the media 108 in the media database 516 or from one or more other storage mediums.

Although the media engine 104 is described as including various components, the media engine 104 may include more components or fewer components than those listed and still fall within the scope of embodiments of the invention. For example, the media engine 104 may also include a media cache/buffer for short term storage of the media 108, an input/output (I/O) component for receiving and sending data at the client 102, a contact database for storing information associated with contact, a user activity component for tracking activity of the user with respect to the media 108 and/or the loop(s) 106, and so forth.

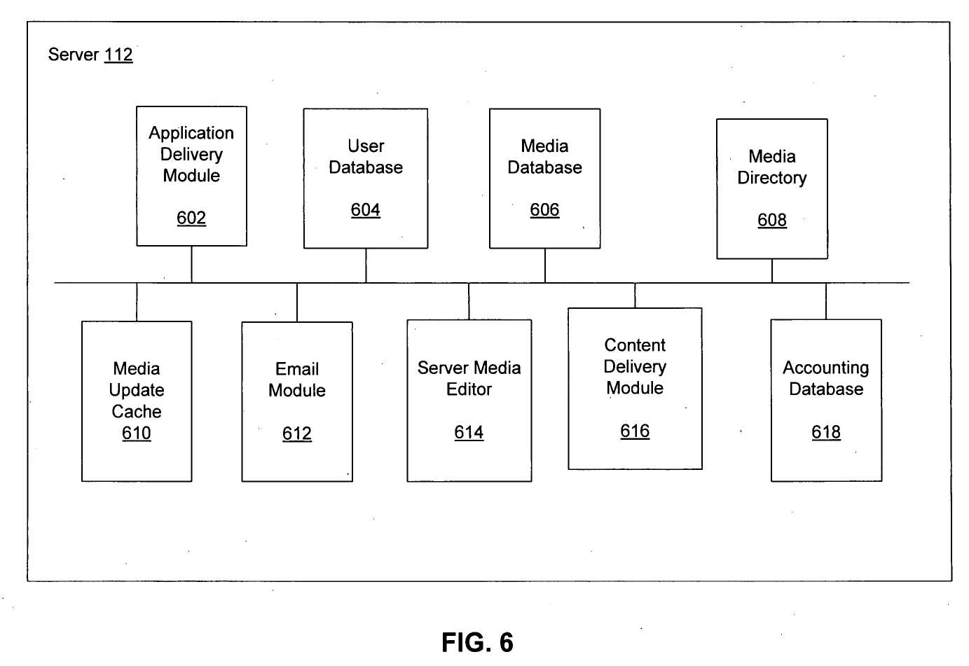

FIG. 6 illustrates exemplary components associated with the server 112 in accordance with one embodiment. A delivery module 602 may be provided for delivering the loop(s) 106 (FIG. 1) and the media 108(FIG. 1) that comprise the loop(s) 106, as well as the identifiers assigned to the loop(s) 106 and the media 108 to clients.

In one embodiment, the media 108 is provided to the media engine 104 for creating the loop(s) 106 utilizing the media 108. The media engine 104 then requests the server 112 create the loop(s) 106 with the media 108 provided. Alternatively, as discussed herein, the media engine 104, itself may create the loop(s) 106. The server 112 and/or the media engine 104 can assign an identifier to the loop(s) 106 and to each of the one or more items of media 108 comprising the loop(s) 106. If the server 112 creates the loop(s) 106 or maintains a master copy of the loop(s) 106, the server 112 can deliver the loop(s) 106 to the media engine 104 via the network 110, as discussed herein. However, any manner of delivering the loop(s) 106 to the media engine 104 is within the scope of various embodiments.

A user database 604 may be provided for storing user information, such as first and last name, electronic mail addresses, user identifiers, and so on. The user database 604 may also store information associated with the loop(s) 106 that the user created or received from other users. Based on the identifiers from the loop(s) 106, the user database 604 can provide the media 108 as updates to the appropriate loop(s) 106 in the loop players 104 running on the client 102 or the client(s) 114. Optionally, a user may be required to register certain information with the server 112 before the server 112 will provide the loop(s) 106 with the media 108 to the loop player(s) 202 (FIG. 2) associated with the user. Alternatively, the user may be required to register in order to receive the identifier for the media 108 and/or the loop(s) 106.

A media database 606 may also be provided for storing the media 108 and/or the loop(s) 106 and/or any metadata or configuration information associated with the loop(s) 106 and/or the media 108. As discussed herein, the media 108 and/or the loop(s) 106 may include, for example, multimedia, photographs, sounds, music, pictures, streaming media, animation, movies, and graphics. Any type of media 108 may comprise the loop(s) 106.

A media directory 608 may be provided for indexing the media 108 stored in the media database 606. For example, in one embodiment, the media directory 608 may allow the loop(s) 106 and/or media 108 to be retrieved that have the word “fishing” in their titles or descriptions. Any indexing and searching by the media directory 608 on any information or metadata associated with the loop(s) 106 or the media 108 is within the scope of various embodiments.

A media update cache 610 stores the media 108 that is utilized to update, or otherwise modify, the loop(s) 106.

An electronic mail module 612 sends electronic mail for the user at the client 102 to the one or more other users at the client(s) 114, providing the users at the client(s) 114 with information for retrieving or constructing the loop(s) 106 and/or the media engine 104.

A server media editor 614 may be provided for modifying the media 108. The user can modify the media 108 utilizing the server media editor 614 via the server 112 rather than, or in addition to, the media engine editor 508 (FIG. 5). For example, the server media editor 614 may be used to resize photos, rotate photos, remove red eye from photos, correct color balance, cleanse the media 108 of viruses, and so forth.

As discussed in FIG. 1, a content provider 116 may be coupled to the server 112. Alternatively, the function of the content provider 116 may be performed by a content delivery module 616 within the server 112. The content delivery module 616 provides advertising and/or any other type of content to be included as one or more items of the media 108 within the loop(s) 106.

In one embodiment, the advertising and/or content from the content delivery module 616 may be provided based on an analysis of the user of the loop(s) 106. For example, an advertisement for toothpaste may be provided to a user with family related loops 106. However, any manner of determining the advertising and/or the content to be provided by the content delivery module 616 to the loop(s) 106 may be employed, such as arbitrarily choosing the advertising and/or the content.

In one embodiment, the media 108 may comprise more than one advertising media inserted into the loop(s) 106. As discussed herein, the content provider 116 and/or the content delivery module 316 may dictate how frequently the advertising media, or other content, appears. For instance, the advertising media may appear twice in the loop(s) 106, once for every five items of the media 108 in the loop(s) 106, and so on.

A commercial loop(s) 106 may also be created utilizing the content delivery module 616. The commercial loop(s) 106 may include media with embedded music, streaming video, audio, and/or other multimedia effects. A user may choose to allow the commercial loop(s) 106 to play on a display device associated with the user's client 102.

The server 112 may also include an accounting module 618. The accounting module 618 can track the media 108 within the loop(s) 106, and track the frequency and type of interaction each of the users has with the loop(s) 106 on the media 108. Specifically, the accounting module 618 is useful for tracking the interaction between the user and the advertisement media included within the loop(s) 106. Accordingly, the accounting module 618 can track monies due to a provider of the advertising media based on user interaction with the advertising media.

Although the server 112 has been described as including various components, fewer or more components may comprise the server 112 in accordance with various embodiments. For instance, the server 112 may also include a search engine component, a communications interface, etc.

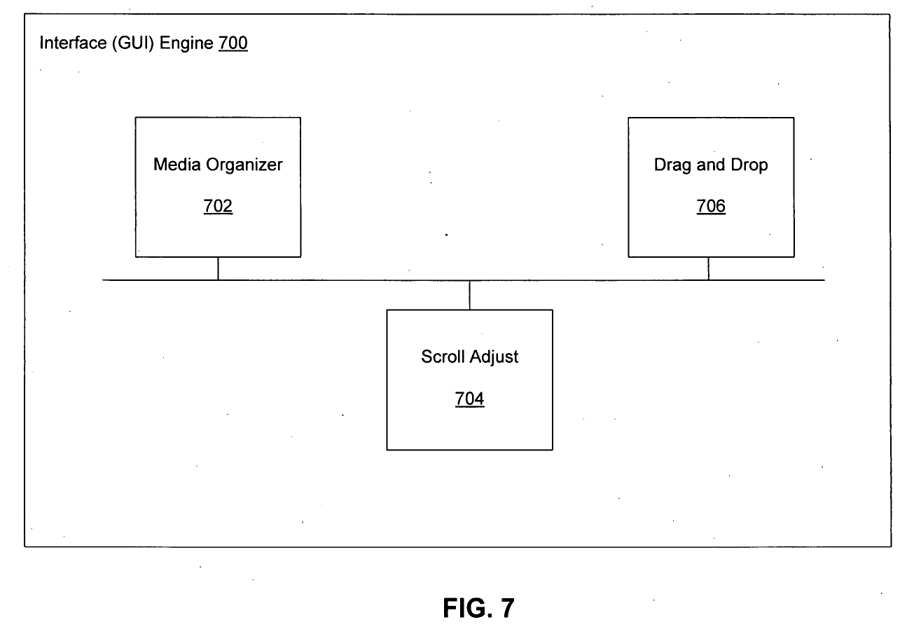

Turning now to FIG. 7, an exemplary graphical user interface (GUI) engine 700 for providing access to functions related to the media engine 104 (FIG. 1) is shown. In one embodiment, the GUI engine 700 is the display module 506 (FIG. 5). A media organizer 702 allows a user to organize the media 108 (FIG. 1) in the loop(s) 106 (FIG. 1). For example, the user can provide photos to the media organizer 702 via a drag and drop function, a keystroke, etc., and the media organizer 702 can automatically organize the photos according to default parameters or parameters specified by the user. The default parameter may be, for instance, to organize the photos according to dates associated with the photos. The user can specify any parameters, such as date, size, event, and so forth, for the media organizer 702 to use in arranging the media 108.

A movement controller 704 provides the user with a mechanism to regulate the pace of the loop(s) 106, as discussed herein, as it scrolls across a display device associated with the client 102. For example, the user may specify that the loop(s) 106 should scroll across the display device at a rate of one display device pixel per tenth of a second. The movement controller 704 also allows the user to specify the direction the loop(s) 106 should scroll across the display device of the client 102. For example, the user may specify that the loop(s) 106 should scroll left to right across the display device. Any manner of allowing the user to adjust the pace may be provided. For instance, the user may enter the scroll time into a box, move a slider between a slowest pace and fastest pace, select from scroll paces from a drop down menu, and so on.

A drag/drop manager 707 provides a mechanism for allowing the user to modify the loop(s) 106 in a single drag and drop action. Thus, the user can drag one or more items of the media 108 into the loop(s) 106. The drag/drop manager 707 communicates the user action and information to other components/modules associated with the media engine 104 for automatically updating the loop(s) 106 to include the dropped media 108. As discussed herein, when the user performs this single act of dragging and dropping the media 108 into the loop(s) 106, one or more other loop(s) 106 that share the identifier are also updated with the dropped media 108. As discussed herein, the other loop(s) 106 may reside in other media engines 104 (FIG. 1) at the client(s) 114. Conversely, the user can drag one or more items of the media 108 away from the loop(s) 106, in order to remove the items. The loop(s) 106 that share the same identifier are also updated to no longer include the media 108 dragged away from the loop(s).

A scroll adjust 704 option may also be provided via the GUI engine 700. The scroll adjust 608 allows the user to manipulate the loop(s) 106 as they scroll across a display device associated with the user, such as the display for the client 102. For instance, as the loop(s) 106 scrolls across the display device, the user can grab the loop(s) 106 with a mouse, keystroke, etc., and move the loop(s) 106. The user can stop the scrolling, slow down the scrolling, speed up the scrolling, and so forth by clicking on, moving, etc. the loop(s) 106, itself. The user can choose which of the loop(s) 106 and/or how many of the loop(s) 106 the user wants to scroll on the user's display device at one time.

Although an exemplary GUI engine 700 has been described, any type of graphical user interface with any type of functionality is within the scope of various embodiments. For example, the GUI engine 700 may include mechanisms for allowing functionality such as creating another loop when the user selects the one or more items of the media 108 comprising the loop(s) 106, displaying a larger image when the user selects the one or more items of the media 108 in the loop(s) 106, dragging and dropping the entire loop(s) 106 from one media engine 104 to another media engine 104, creating a new empty loop 106 from when the user selects an item of the media 108 in the loop(s) 106, sending an electronic mail message to other users that contains a copy of the entire loop(s) 106 or information related to specific loops 106, providing the ability to search for various loops 106 associated with the client 102, client(s) 114, and/or stored in a publicly accessible media directory 608, and so forth.

The process of providing an interface for interacting with a loop is described in further detail in co-pending U.S. Application serial number entitled “Systems and Methods for Providing an Interface for Interacting with a Loop,” filed on Jul. 1, 2005, which is incorporated by reference.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the media applications may employ any of the desired functionality set forth hereinabove. Thus, the breadth and scope of a preferred embodiment should not be limited by any of the above-described exemplary embodiments.

What is claimed is:

1. A method for providing a loop, comprising:
receiving one or more items of media;
assigning an identifier to the one or more items of media;
creating a loop with the one or more items of media;
playing the loop by displaying the one or more items of media in a selected order.

2. The method recited in claim 1, wherein the identifier is received from a server.

3. The method recited in claim 1, wherein the order is determined according to a date associated with each of the one or more items of media.

4. The method recited in claim 1, wherein the order is determined according to a subject matter associated with each of the one or more items of media.

5. The method recited in claim 1, wherein a media engine is utilized to play the one or more items of media in the loop.

6. The method recited in claim 1, further comprising updating the loop with one or more items of media that a user forwards to the loop.

7. The method recited in claim 1, further comprising updating the loop according to one or more items of media that a user removes from the loop.

8. A method for modifying a loop, comprising:
creating a loop having a first identifier;
selecting one or more items of media to be added to the loop;
assigning a second identifier to the one or more items of media;
associating the first identifier with the second identifier; and
including the one or more items of media in the loop based on the associated first identifier and second identifier.

9. The method recited in claim 8, wherein the user forwards the one or more items of media to the loop by dragging and dropping the one or more items of media into the loop.

10. The method recited in claim 8, wherein the user forwards the one or more items of media to the loop by initiating a voice command specifying the loop to which the one or more items of media should be forwarded.

11. The method recited in claim 8, wherein the user forwards the one or more items of media to the loop by selecting the loop from a drop down menu.

12. A system for providing a drag and drop loop, comprising:
a loop;
a server configured for associating the loop with one or more items of media received from a user; and
a media engine for modifying the loop based on the user interaction with the loop.

13. The system recited in claim 12, wherein the user interaction includes adding by dragging and dropping at least one of the one or more items of media into the loop.

14. The system recited in claim 12, wherein the user interaction includes removing by dragging at least one of the one or more items of media away from the loop.

15. The system recited in claim 12, wherein the user interaction includes modifying the one or more items of media that populate the loop by making changes to the one or more items of media within the loop.

16. A system for providing a modifiable loop, comprising:
a server for providing a loop, receiving one or more items of media a user designates as belonging to the loop, and associating the loop with the one or more items of media;
a content provider for providing advertising content to the loop;
a media engine for playing the loop and forwarding the one or more items of media to the server for populating the loop and updating the loop.

17. A method for providing a modifiable loop, comprising:
creating a loop;
receiving one or more items of media from a user;
populating the loop with the one or more items of media; and
modifying the loop according to user interaction with the loop.

18. The method recited in claim 17, wherein the user interaction includes dragging at least one of the one or more items of media away from the loop.

19. The method recited in claim 18, wherein the modification includes removing at least one of the one or more items of media from the loop.

20. The method recited in claim 17, wherein the user interaction includes providing at least one additional item of media to the loop.

21. The method recited in claim 20, wherein the modification includes adding the at least one additional item of media to the loop.

22. The method recited in claim 20, wherein the user provides the at least one additional item of media to the loop by dragging the at least one additional item of media into the loop.

23. The method recited in claim 17, wherein the user interaction includes modifying the one or more items of media within the loop.

24. The method recited in claim 17, wherein the user interaction includes moving at least one of the one or more items of media from a first position within the loop to a second position within the loop.
